(19) United States
(12) Patent Application Publication
(10) Pub. No.: US 2025/0219708 A1
(43) Pub. Date: Jul. 3, 2025

(54) REPEATING METHOD AND DEVICE OF ACCESS LINK OF REPEATER

(71) Applicant: FUJITSU LIMITED, Kawasaki-shi (JP)

(72) Inventors: Yan TIAN, Beijing (CN); Qinyan JIANG, Beijing (CN); Lei ZHANG, Beijing (CN)

(73) Assignee: FUJITSU LIMITED, Kawasaki-shi (JP)

(21) Appl. No.: 19/087,699

(22) Filed: Mar. 24, 2025

Related U.S. Application Data
(63) Continuation of application No. PCT/CN2022/122685, filed on Sep. 29, 2022.

(51) Int. Cl. H04B 7/06; H04L 5/00

(52) U.S. Cl. CPC H04B 7/06952; H04L 5/0053

(57) ABSTRACT

A network controlled repeater (NCR) includes: a NCR-MT (Mobile Termination) processor circuitry configured to receive a beam index of an access link from a network device; and a NCR-Fwd (Forwarding) processor circuitry configured to perform forwarding on the access link by using a beam to which a received beam index corresponds.

### CROSS-REFERENCE TO RELATED APPLICATION

This application is a continuation application under 35 U.S.C. 111 (a) of International Patent Application PCT/CN2022/122685 filed on Sep. 29, 2022, and designated the U.S., the entire contents of which are incorporated herein by reference.

### TECHNICAL FIELD

This disclosure relates to the field of communications.

### BACKGROUND

Compared with related 2G (second generation mobile communication technology), 3G (third generation mobile communication technology) and 4G (fourth generation mobile communication technology) systems, a 5G (fifth generation mobile communication technology) system is able to provide larger bandwidths and higher data rates, and is able to support more types of terminals and vertical services. For this reason, frequency band ranges/operating bandwidths supported by 5G systems are obviously higher than those of 2G, 3G and 4G systems, and 5G systems support higher carrier frequencies. For example, 5G systems may be deployed in a millimeter waveband.

However, the higher a carrier frequency, the more severe a fading experienced by signals during transmission. Therefore, in actual deployment of a 5G system, especially in a millimeter waveband, how to better enhance cell coverage has become an urgent problem to be solved.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In order to better solve the coverage problem of cellular mobile communication systems in practical deployment, use of a radio frequency (RF) repeater to amplify and forward signals between devices is commonly used means of deployment. RF repeaters are widely used in actual deployment of 2G, 3G and 4G systems, with advantages of low cost, easy deployment and increasing less latency. Generally speaking, a related RF repeater is a device that amplifies and forwards signals between devices. That is, a related RF repeater is a non-regenerative relay node, which only directly amplifies and forwards all received signals.

The RF repeater proposed in researches of Rel-17 3GPP is able to forward transmissions between a base station and a terminal to enhance network coverage of a 5G system. However, as the RF repeater is transparent to both a base station and a terminal and is not controlled by the base station, the RF repeater in Rel-17 causes interference to other devices and its energy consumption cannot be controlled, and a state of monitoring the forwarding needs to be maintained all times.

In researches of Rel-18, it was proposed that a network-controlled repeater (NCR) is able to receive network side control information. The NCR includes an NCR-MT (also referred to as a communication unit) and an NCR-Fwd (also referred to as a forwarding unit), wherein the NCR-MT is able to communicate with a base station and control forwarding of the NCR-Fwd according to control information transmitted by the base station. The NCR-Fwd is a part constituting the NCR and implementing forwarding between the base station and the terminal, and includes a backhaul link (BH link) connecting the NCR and the base station and an access link (AC-link) at the terminal side.

In order that the NCR better enhances coverage, accurately forwards the communications between the base station and the terminal, and reduces interference to other surrounding devices, the base station controls and instructs backhaul link beams and access link beams of the NCR-Fwd. Currently, it is only determined that a beam index may be used for beam management of the access link.

It was found by the inventors that in the related art, there is no specific solution for how to determine a beam index and how to use the beam index for beam management of access links. That is, there is no effective beam management mechanism for access links, which leads to an inability to determine beams of the access link of the NCR and effectively utilize the beam index and complete forwarding between the terminal and the base station.

In order to solve one or more of the above problems, embodiments of this disclosure provide a repeating method and device of an access link of a repeater. That is, addressed to one or more of the above problems, embodiments of this disclosure provide corresponding solutions.

According to a first aspect of the embodiments of this disclosure, there is provided a repeating device of an access link of a repeater, the device being provided in a repeater, and the device including: a receiving unit configured to receive a beam index of an access link from a network device; and a repeating unit configured to perform repeating by using a beam to which the received beam index corresponds.

According to a second aspect of the embodiments of this disclosure, there is provided a device for indicating a beam index of an access link of a repeater, the device being provided in a network device, and the device including: a first indicating unit configured to indicate a beam index of an access link to a repeater.

According to a third aspect of the embodiments of this disclosure, there is provided a repeater, including the device according to the first aspect of the embodiments of this disclosure.

According to a fourth aspect of the embodiments of this disclosure, there is provided a network device, including the device according to the second aspect of the embodiments of this disclosure.

According to a fifth aspect of the embodiments of this disclosure, there is provided a communication system, including the repeater according to the third aspect of the embodiments of this disclosure, and/or the network device according to the fourth aspect of the embodiments of this disclosure, and a terminal equipment.

According to a sixth aspect of the embodiments of this disclosure, there is provided a repeating method of an access link of a repeater, the method including: receiving a beam index of an access link from a network device by a receiving unit of the repeater; and performing repeating by a repeating unit of the repeater by using a beam to which the received beam index corresponds.

According to a seventh aspect of the embodiments of this disclosure, there is provided a method for indicating a beam index of an access link of a repeater, the method including: indicating a beam index of an access link by a network device to a repeater.

According to an eighth aspect of the embodiments of this disclosure, there is provided a computer readable program, which, when executed in a repeating device of an access link of a repeater or a repeater, will cause the repeating device of an access link of a repeater or the repeater to carry out the repeating method of an access link of a repeater as described in the embodiment of the sixth aspect of the embodiments of this disclosure.

According to a ninth aspect of the embodiments of this disclosure, there is provided a computer readable medium, including a computer readable program code, which will cause a repeating device of an access link of a repeater or a repeater to carry out the repeating method of an access link of a repeater as described in the embodiment of the sixth aspect of the embodiments of this disclosure.

According to a tenth aspect of the embodiments of this disclosure, there is provided a computer readable program, which, when executed in a repeating device of an access link of a repeater or a network device, will cause the repeating device of an access link of a repeater or the network device to carry out the method for indicating a beam index of an access link of a repeater as described in the embodiment of the seventh aspect of the embodiments of this disclosure.

According to an eleventh aspect of the embodiments of this disclosure, there is provided a computer readable medium, including a computer readable program code, which will cause a repeating device of an access link of a repeater or a network device to carry out the method for indicating a beam index of an access link of a repeater as described in the embodiment of the seventh aspect of the embodiments of this disclosure.

An advantage of the embodiments of this disclosure exists in that:
the repeater performs forwarding on the access link by using the beam corresponding to the beam index of the access link according to the beam index of the access link received from the network device, so that the network device is able to schedule the access link beams of the repeater used for forwarding, and the repeater is able to determine the forwarded access link beams. Hence, the beam index may be effectively utilized and forwarding between the terminal and the network device may be completed.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of an embodiment of this disclosure;

FIG. 2 is a logical schematic diagram of a repeater of an embodiment of this disclosure;

FIG. 3 is a schematic diagram of a repeating method of an access link of a repeater of embodiment 1 of this disclosure;

FIG. 4 is a schematic diagram of a beam index of embodiment 1 of this disclosure;

FIG. 5 is a schematic diagram of a relationship between beams of embodiment 1 of this disclosure;

FIG. 6 is a schematic diagram of an MAC CE of embodiment 1 of this disclosure;

FIG. 7 is a schematic diagram of a method for indicating a beam index of an access link of a repeater of embodiment 2 of this disclosure;

FIG. 8 is an interaction graph of carrying out a repeating method of an access link of a repeater of embodiment 2 of this disclosure;

FIG. 9 is a schematic diagram of a repeating device of an access link of a repeater of embodiment 3 of this disclosure;

FIG. 10 is a schematic diagram of a device for indicating a beam index of an access link of a repeater of embodiment 4 of this disclosure;

FIG. 11 is another schematic diagram of the device for indicating a beam index of an access link of a repeater of embodiment 4 of this disclosure;

FIG. 12 is a further schematic diagram of the device for indicating a beam index of an access link of a repeater of embodiment 4 of this disclosure;

FIG. 13 is a schematic diagram of a systematic structure of a repeater of embodiment 5 of this disclosure; and

FIG. 14 is a schematic diagram of a systematic structure of a network device of embodiment 6 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, “multiple” refers to at least two (two or more).

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “a terminal equipment (TE)” refers to, for example, an equipment accessing to a communication network and receiving network services via a network device. The terminal equipment may be fixed or mobile, and may also be referred to as a mobile station (MS), a terminal, a subscriber station (SS), or an access terminal (AT), etc.

Wherein, the user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In the embodiments of this disclosure, “a repeater” is a relay device, such as a relay device provided in a serving cell to which a network device corresponds, which is used to forward transmission signals between the network device and terminal equipments. In addition, it may be referred to as a repeater node.

In the embodiments of this disclosure, the forwarding of the repeater includes uplink forwarding and/or downlink forwarding. The uplink forwarding includes forwarding channels and/or signals transmitted by a terminal equipment to a network device, and the downlink forwarding includes forwarding channels and/or signals transmitted by a network device to a terminal equipment.

In the embodiments of this disclosure, the repeater has a communication function, that is, the repeater is able to receive information (including channels and/or signals) from the network device, i.e. downlink transmission, and/or transmit information (including channels and/or signals) to the network device, i.e. uplink transmission.

The receiving information (downlink transmission) includes at least one of detecting a sequence, demodulating, descrambling, decoding, and interpreting information, etc, and the transmitting information (uplink transmission) includes at least one of generating information, generating a sequence, scrambling, encoding, modulating, and mapping to a time-frequency resource, etc. A process of forwarding information (uplink forwarding and/or downlink forwarding) does not include at least one of the above processings included in the receiving information (downlink transmission) and/or the transmitting information (uplink transmission).

In the embodiments of this disclosure, the communication between the repeater and the network device is also referred to as transmission of the repeater.

In the embodiments of this disclosure, the repeater may be referred to as a network-controlled repeater (NC-repeater). However, other names may also be used, and various names of the repeater are not intended to limit the embodiments of this disclosure.

In the embodiments of this disclosure, the repeater may include a communication unit (NCR-MT, also referred to as an MT unit) and a forwarding unit (NCR-Fwd, also referred to as an RU module). The communication unit is used to support a communication function between the repeater and the network device (such as the above receiving and/or transmitting information), and includes, for example, a receiving unit and a transmitting unit, and the forwarding unit is used to support the forwarding function of the repeater.

In the embodiments of this disclosure, a link between the network device and the communication module is a communication link or a control link. The communication unit or receiving unit of the repeater may receive information from the network device via the communication link or control link, and the communication link or control link may be based on an existing Uu interface. Moreover, the communication unit or receiving unit of the repeater may apply information received from the network device to the forwarding unit via internal operations of the repeater.

In the embodiment of this disclosure, the beam may also be expressed as a reference signal (RS), a transmission configuration indication (TCI), or a spatial domain filter, etc., or may be expressed as a beam index, a reference signal index, a transmission configuration indication index, or a spatial domain filter index, etc. The above reference signal is, for example, a CSI-RS, or an SRS, or an RS for use by the repeater, or an RS transmitted by the repeater, etc. And the above TCI may also be expressed as a TCI state.

In the embodiments of this disclosure, there is a beam correspondence between uplink beams and downlink beams, that is, the uplink beams and downlink beams are common.

Scenarios of the embodiments of this disclosure and problems shall be described below by way of examples; however, the embodiments of this disclosure are not limited thereto.

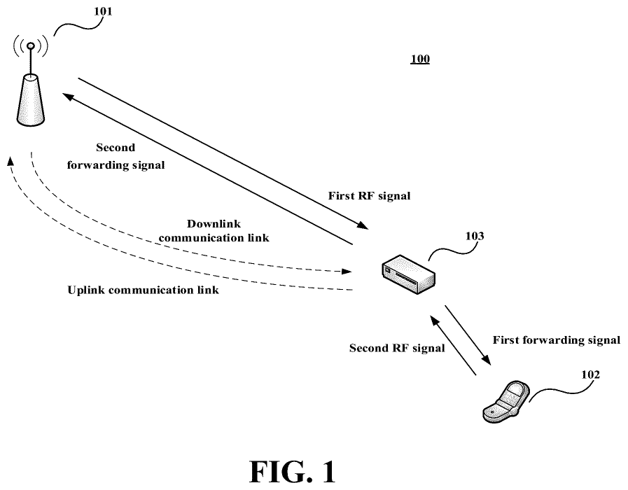

FIG. 1 is a schematic diagram of a communication system of an embodiment of this disclosure. As shown in FIG. 1, the communication system 100 may include a network device 101, a terminal equipment 102 and a repeater 103.

In the embodiment of this disclosure, existing traffics or traffics that may be implemented in the future may be performed between the network device 101 and the terminal equipment 102. For example, such traffics may include but not limited to enhanced mobile broadband (eMBB), massive machine type communication (mMTC), and ultra-reliable and low-latency communication (URLLC), etc.

As shown in FIG. 1, the repeater 103 receives a first RF signal from the network device 101, amplifies the first RF signal to obtain a first forwarding signal and transmits it to the terminal equipment 102, and/or, the repeater 103 receives a second RF signal from the terminal equipment 102, amplifies the second RF signal to obtain a second forwarding signal and transmits it to the network device 101.

In addition, as shown in FIG. 1, communication between the repeater 103 and the network device 101 may be performed via a downlink communication link (down C-link) and/or an uplink communication link (up C-link).

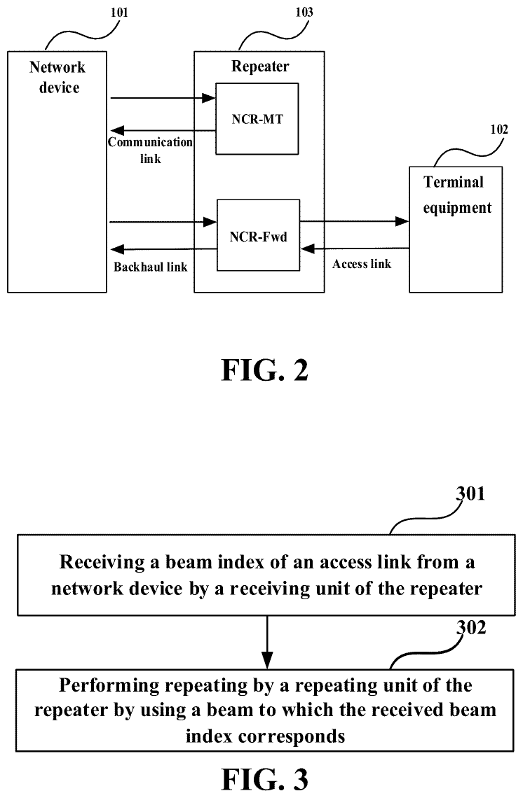

FIG. 2 is a logical schematic diagram of the repeater of the embodiment of this disclosure. As shown in FIG. 2, the repeater 103 includes an NCR-MT (also referred to as a communication unit) and an NCR-Fwd (also referred to as a forwarding unit), wherein the NCR-MT is able to communicate with the network device 101 and control forwarding of the NCR-Fwd according to control information transmitted by the network device 101. For example, the NCR-MT includes a receiving unit and a transmitting unit, wherein the receiving unit receives the control information from the network device 101, and the transmitting unit transmits relevant information to the network device 101. The NCR-Fwd is a part implementing forwarding between the network device 101 and the terminal equipment 102, and includes a backhaul link (BH-link) connecting the repeater 103 and the network device 101 and an access link (AC-link) connected to the terminal equipment 102.

Implementations of the embodiments of this disclosure shall be described below with reference to the accompanying drawings. These implementations are illustrative only, and are not intended to limit this disclosure.

### Embodiment 1

The embodiment of this disclosure provides a repeating method of an access link of a repeater, applicable to a repeater, such as the repeater 103 in FIGS. 1 and 2.

FIG. 3 is a schematic diagram of the repeating method of an access link of a repeater of embodiment 1 of this disclosure. As shown in FIG. 3, the method includes:
step 301: receiving a beam index of an access link from a network device by a receiving unit of the repeater; and
step 302: performing repeating by a repeating unit of the repeater by using a beam to which the received beam index corresponds.

In this way, the repeater performs forwarding on the access link by using the beam corresponding to the beam index of the access link according to the beam index of the access link received from the network device, so that the network device is able to schedule the access link beams of the repeater used for forwarding, and the repeater is able to determine the forwarded access link beams. Hence, the beam index may be effectively utilized and forwarding between the terminal and the network device may be completed.

In some embodiments, the repeater is a network-controlled repeater, i.e. an NCR.

In some embodiments, the receiving unit of the repeater is a part of an NCR-MT or an NCR-MT, and the forwarding unit of the repeater is an NCR-Fwd. For example, reference may be made to a related structure in FIG. 2.

In some embodiments, the beam index (also referred to as the beam number) labels beams of the access link (AC-link), beam indices are obtained, and the network device indicates the beam index forwarded by the repeater.

In addition, the beam index may also be expressed as a beam number or a beam label, etc.

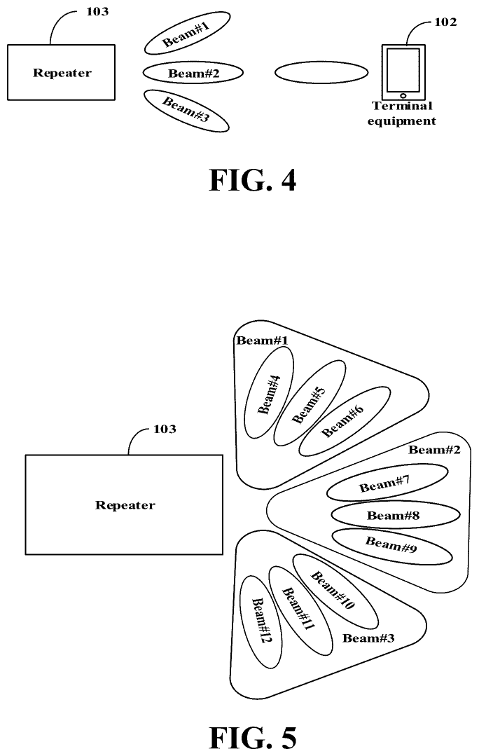

FIG. 4 is a schematic diagram of the beam index in embodiment 1 of this disclosure. As shown in FIG. 4, the beams of the access link of the repeater are labeled, wherein the beam index includes beam #1, beam #2, and beam #3. In addition, beam index may also be expressed in other forms, which are not limited in the embodiment of this disclosure.

In some embodiments, the beam index received by the repeater is indicated via at least one of RRC signaling, an MAC CE, and physical layer signaling.

The physical layer signaling is, for example, DCI, or may also be other physical layer signaling.

In this way, by indicating the beam index of the access link via the physical layer signaling, signaling overhead and transmission delay of indicating the beam index are reduced, thereby improving utilization efficiency of the system.

In some embodiments, the beam index received by the repeater is at least one of beam indices of access links configured by the network device, that is, the network device determines beam indices of access links and indicates at least one of the determined beam indices to the repeater.

For example, the beam index of the access link configured by the network device is beam #1, beam #2, beam #3, . . . . When the repeater needs to perform forwarding on the access link, the beam index indicated by the network device to the repeater (i.e. the beam index received by the repeater) is at least one of beam #1, beam #2, beam #3, . . . configured by the network device, and the repeater uses a beam to which the received beam index corresponds to perform forwarding on the access link, wherein a correspondence between beam indices and beams configured by the network device is determined by implementation of the repeater.

In some embodiments, alternatively, the beam index received by the repeater is at least one of beam indices of access links reported by the repeater, that is, the repeater determines and reports beam indices of access links, and the network device indicates at least one of the beam indices reported by the repeater to the repeater.

For example, the repeater reports beam indices beam #1, beam #2, beam #3, . . . to the network device, and when the repeater needs to perform forwarding on the access link, the beam index indicated by the network device to the repeater (i.e. the beam indices received by the repeater) is at least one of beam #1, beam #2, beam #3, . . . reported by the repeater, and the repeater uses a beam to which the received beam index corresponds to perform forwarding on the access link, wherein the correspondence between beam indices and beams configured by the network device is determined by implementation of the repeater.

In the case where the beam index received by the repeater is at least one of the beam indices of access links configured by the network device, for example, the beam index is configured by the network device according to information reported by the repeater.

In some embodiments, the information reported by the repeater includes at least one of the number of beams supported by the access link, a relationship between the beams of the access link, and whether simultaneous forwarding on beams of different access links is supported.

In some embodiments, the number of beams supported by the access link includes at least one of the following: a total number of beams supported by the access link, a total number of repeated beams supported by the access link, a total number of simultaneously repeated beams supported by the access link, and the number of beams of different types.

In some embodiments, different types of beams are beams in different directions, or beams with different widths, or beams of different accuracies.

In addition, the relationship between beams and the directions and widths of the beams shall be described below in detail.

In some embodiments, whether simultaneous forwarding on beams of different access links is supported includes at least one the number of beams supported for simultaneous forwarding, that accuracies of beams supported for simultaneous forwarding are identical or different, and a relationship between beams supported for simultaneous forwarding.

For the case where the beam index received by the repeater is at least one of the beam indices of the access links configured by the network device, in the above example, the network device configures the beam indices the access links according to the information reported by the repeater. For another example, the beam index of the access link is configured by the network device, that is, the network device independently determines the beam index of the access link without needing the repeater to report information.

For the case where the beam index received by the repeater is at least one of the beam indices of the access links configured by the network device, the method may further include: receiving information on a relationship between beams to which the beam indices correspond by the repeater from the network device. That is, the network device further indicates information the relationship between the beams to which the beam indices of the access links correspond to the repeater.

For the case where the beam index received by the repeater is at least one of the beam indices of the access links reported by the repeater, the method may further include: reporting the information on a relationship between the beams to which the beam indices correspond by the repeater to the network device.

In some embodiments, the network device indicates according to the beam index of the access link reported by the repeater, that is, the network device is not needed to process the beam index of the access link.

Alternatively, the network device indicates the beam index to the repeater after processing the beam indices of the access links reported by the repeater. For example, the network device re-labels the beam indices of the access links reported by the repeater according to a reference value, such as labeling 0, 1, 2, 3 starting from beam #4 reported by the repeater.

The relationship between the beams shall be described below in detail.

In some embodiments, the relationship between the beams may also be referred to as a QCL (quasi-colocation) relationship between the beams or a spatial relationship (spatial relation) between the beams.

In some embodiments, the relationship between the beams is a relationship between beams to which different beam indices correspond.

For example, the relationship between the beams at least includes that the beams to which the different beam indices correspond are in different directions, or that the beams to which the different beam indices correspond are in the same direction with different widths.

In some embodiments, a width of the beam may also be expressed as an accuracy (precision) of the beam or a type of the beam.

FIG. 5 is a schematic diagram of the relationship between the beams in embodiment 1 of this disclosure. As shown in FIG. 5, beams to which beam #1 corresponds are respectively in the same direction as beam #4, beam #5 and beam #6, beams to which beam #2 corresponds are respectively in the same direction as beam #7, beam #8 and beam #9, beams to which beam #3 corresponds are respectively in the same direction as beam #10, beam #11 and beam #12.

In addition, the beams to which beam #1 corresponds, the beams to which beam #2 corresponds and beams to which beam #3 corresponds are beams in different directions, the beams to which beam #4, beam #5 and beam #6 correspond are beams in different directions, the beams to which beam #7, beam #8 and beam #9 correspond are beams in different directions, and the beams to which beam #10, beam #11 and beam #12 correspond are beams in different directions.

In some embodiments, the relationship between beams may include type 1 and type 2, wherein type 1 refers to that two beams are in different directions, such as the beam to which beam #1 corresponds and the beam to which beam #2 corresponds, the beam to which beam #4 corresponds and the beam to which beam #3 corresponds, beam to which beam #5 corresponds and the beam to which beam #8 corresponds, and beam to which beam #11 corresponds and the beam to which beam #12 corresponds in FIG. 5; and type 2 refers to that two beams are in the same direction with different widths (different accuracies or types), such as the beam to which beam #1 corresponds and the beam to which beam #4 corresponds, and the beam to which beam #2 corresponds and the beam to which beam #9 corresponds in FIG. 5.

As described above, in some embodiments, the network device may determine the relationship between the beams of the access links, i.e. the relationship between the beams to which different beam indices correspond, and indicate the relationship to the repeater.

For example, the network device uses a bit to indicate whether a relationship between beams to which beam #1 and beam #2 correspond is type 1 or type 2. For example, if the bit indicates “0”, it means that the relationship between the beams to which beam #1 and beam #2 correspond is type 1, and if the bit indicates “1”, it means that the relationship between beams to which beam #1 and beam #2 correspond is type 2.

For another example, the network device indicate that beams to which beam indices in the same set correspond are beams with different widths (different accuracies or types) in the same direction. For example, set 1 is {beam #1, beam #4, beam #5, beam #6}, and set 2 is {beam #2, beam #7, beam #8}.

For a further example, the network device indicates beams with identical widths (or accuracies or types) in a set, for example, set 1 is {beam #1, beam #2, beam #3}, and set 2 is {beam #5, beam #6, beam #7}.

As described above, in some embodiments, the repeater may determine the relationship between the beams of the access link, i.e. the relationship between the beams to which different beam indices correspond, and report the relationship to the network device.

For example, the repeater uses a bit to report whether a relationship between a beam to which beam #1 corresponds and a beam to which beam #2 corresponds is type 1 or type 2. For example, if the bit indicates “0”, it means that the relationship between the beam to which beam #1 corresponds and the beam to which beam #2 corresponds is type 1, and if the bit indicates “1”, it means that the relationship between the beam to which beam #1 corresponds and the beam to which beam #2 corresponds is type 2.

For another example, the repeater reports the beam indices, beams to which beam indices in the same set correspond being beams of different widths (different accuracies or types) in the same direction. For example, set 1 is {beam #1, beam #4, beam #5, beam #6}, and set 2 is {beam #2, beam #7, beam #8}.

For a further example, a repeater reports beams of identical widths (or accuracies or types) in a set. For example, set 1 is {beam #1, beam #2, beam #3}, and set 2 is {beam #5, beam #6, beam #7}.

In some embodiments, the repeater may support one of the reporting modes in the above examples, or the repeater may simultaneously support multiple reporting modes in the above examples.

Additionally, in some embodiments, the relationship between beams to which different beam indices correspond may be specified by default.

For example, whether the relationship between beams to which beam indices correspond is type 1 or type 2 is specified.

For another example, it is specified that beams to which certain beam indices correspond are beams of different widths (different accuracies or types) in the same direction.

For a further example, it is specified that beams to which certain beam indices correspond are beams of identical widths (identical accuracies or types) in different directions.

As described above, the beam index of the access link received by the repeater is configured by the network device or reported by the repeater.

In addition, in some embodiments, the beam information of the access link of the repeater is specified by default.

For example, it is specified by default that a maximum number of beams of the access link supported by the repeater is M, such as 8 or 4,

For another example, simultaneously forwarding on M beams of the access link supported by the repeater is specified by default.

For a further example, the relationship between the beams of the access link of the repeater is specified by default.

In some embodiments, a corresponding beam index is indicated by a first number of bits to the beam index received by the repeater.

For example, the first number is determined by a total number of beam indices of the access link, or is determined by a total number of forwarded beams supported by the access link, or is determined by a total number of beam indices received by the repeater. For example, corresponding index numbers are indicated by log₂ M bits to the beam indices; where, M is the first number.

In some embodiments, alternatively, the beam indices received by the repeater indicate corresponding beam indices in a bitmap manner.

For example, the number of bits in the bitmap is the total number of the beam indices of the access link, or the number of bits in the bitmap is the total number of forwarded beams supported by the access link, or the number of bits in the bitmap is the total number of beam indices received by the repeater.

In some embodiments, the network device indicates that the beam index may be in multiple modes.

For example, mode 1: the beam index received by the repeater (i.e. the beam index indicated by the network device) is at least one of the beam indices of the access links reported by the repeater, or the beam index received by the repeater is at least one of the beam indices of the access links configured by the network device.

That is, the beam index received by the repeater is at least one (all or a part) of the beam indices of the access links reported by the repeater, or the beam index received by the repeater is at least one (all or a part) of the beam indices of the access links configured by the network device.

For example, mode 2: the network device configures at least one beam index in the beam indices of the access links configured by the network device or at least one beam index in the beam indices of the access links reported by the repeater via RRC signaling. That is, for the case where the network device configures the beam indices of the access links, what is configured via the RRC signaling is at least one beam index in the beam indices of the access links configured by the network device, and for the case where the repeater reports the beam indices of the access links, what is configured via the RRC signaling is at least one beam index in the beam indices of the access links reported by the repeater.

A first part of the beam indices is activated via an MAC CE, and a second part of the beam indices is indicated via a domain of physical layer signaling, the first part of the beam indices including at least one beam index of beam indices configured by the RRC signaling, the second part of the beam indices including at least one beam index of the first part of beam indices, and the beam indices received by the repeater being the second part of the beam indices. For example, the physical layer signaling is DCI.

Following description shall be given by way of examples.

The repeater may be configured with up to MI beam indices by the RRC signaling, so that the access link forwards transmission of a terminal equipment in a designated serving cell. For example, MI is determined by an ability of the repeater to support the number of the beams of the access links, and is a positive integer, such as 128. Each beam index corresponds to the beam of the access link of the repeater, and a correspondence therebetween being determined by implementation of the repeater.

For example, in order that the repeater forwards downlink and uplink transmissions between the terminal equipment and the network device, the repeater is configured with a list of up to 128 beam indices, which is configured in the RRC signaling.

The repeater receives an activation instruction in an MAC CE, the activation instruction being for mapping up to M2 beam indices, each corresponding to an uplink or downlink beam forwarded the access link of the repeater; where, M2 is a positive integer, and is less than or equal to M1.

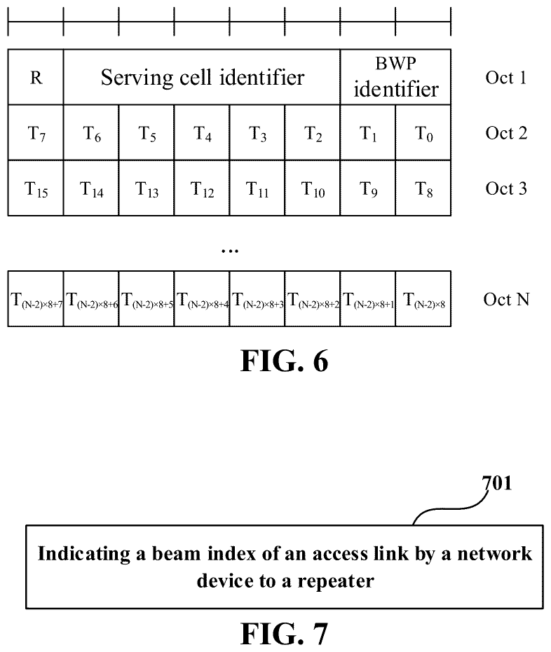

FIG. 6 is a schematic diagram of the MAC CE in embodiment 1 of this disclosure. It should be noted that the MAC CE shown in FIG. 6 is an example only, and the MAC CE of the embodiment of this disclosure may be in various other structures.

For example, if beam indices are configured in the RRC signaling, a domain Ti in the MAC CE indicates an activated or deactivated state of a beam index i (beam #i); otherwise, it ignores the domain Ti in the MAC CE. As shown in FIG. 6, when the domain Ti is set to be 1, it indicates that the beam index i (beam #i) is activated and is mapped to codewords in DCI indicating that the access link forwards beam indices; and when the domain Ti is set to be 0, it indicates that the beam index i (beam #i) is deactivated and is not mapped to the codewords in DCI indicating that the access link forwards beam indices.

If the activation instruction is mapped to the codewords in the DCI, the repeater applies the beam index indicated by the codewords in the DCI to forward the downlink and uplink transmissions between the terminal equipment and the network device. The codewords in DCI for mapping beam indices are determined in a (ascending) order of setting Ti to be 1, that is, a codeword in the DCI mapped by a first Ti set to be 1 is 0, a codeword in the DCI mapped by a second Ti set to be 1 is 1, and so on. A maximum number of activated beam indices is M2. The codewords in the DCI mapping the beam indices indicate at most N beam indices, and the number of codewords in the DCI indicating beam index domains is N log₂ M2; where, N is a positive integer, and is less than or equal to M2.

For example, the number of the activated beam indices is 8 at most. If the DCI indicates that a beam index is invalid, a codeword in the DCI is of 0 bit; otherwise, it indicates that a beam index is of 3 bits.

For example, the domain in the MAC CE activates T4, T20, T22, in the DCI, indicating 0 represents beam #4, indicating 1 represents beam #20, and indicating 2 represents beam #22.

For another example, the codeword in the DCI indicating beam indices indicates 2 beam indices, and the codeword in the DCI is of 6 bits.

In some embodiments, the beam index received by the repeater includes a first beam index configured by the network device or reported by the repeater indicated by the network device, and a second beam index configured via RRC signaling and activated via an MAC CE by the network device and indicated by a domain of physical layer signaling. That is, the beam index received by the repeater is the first beam index and the second beam index indicated by the network device in the above mode 1 and mode 2.

In some embodiments, whether the network device indicates the first beam index or the second beam index to which the beam forwarding the signal corresponds according to the above mode 1 or mode 2 may be determined according to a type of the forwarded signal.

For example, a beam of the repeater forwarding a broadcast signal corresponds to the first beam index indicated by the network device in the above mode 1, and a beam of the repeater forwarding a terminal-specific signal corresponds to the second beam index indicated by the network device in the above mode 2.

In some embodiments, whether the network device indicates the first beam index or the second beam index to which a beam receiving a beam configuration corresponds according to the above mode 1 or mode 2 may be determined according to whether the received beam configuration is a semi-static beam configuration or a dynamic beam configuration.

For example, the beam of the repeater receiving the semi-static beam configuration corresponds to the first beam index indicated by the network device according to above mode 1, and the beam of the repeater receiving the dynamic beam configuration corresponds to the second beam index indicated by the network device according to above mode 2.

In some embodiments, whether the network device indicates the first beam index corresponding to the beam according to mode 1 or indicates the second beam index corresponding to the beam according to mode 2 may be determined according to the widths or the types or the accuracies of the beams of the access links.

For example, wide beams of the access links of the repeater correspond to the first beam index indicated by the network device according to the above mode 1, and narrow beams of the access links of the repeater correspond to the second beam index indicated by the network device according to the above mode 2; in other words, low-accuracy beams of the access links of the repeater correspond to the first beam index indicated by the network device according to the above mode 1, and high-accuracy beams of the access links of the repeater correspond to the second beam index indicated by the network device according to the above mode 2.

It can be seen from the above embodiment that the repeater performs forwarding on the access link by using the beam corresponding to the beam index of the access link according to the beam index of the access link received from the network device, so that the network device is able to schedule the access link beams of the repeater used for forwarding, and the repeater is able to determine the forwarded access link beams. Hence, the beam index may be effectively utilized and forwarding between the terminal and the network device may be completed.

### Embodiment 2

Embodiment 2 of this disclosure provides a method for indicating a beam index of an access link of a repeater, applicable to a network device side. This method corresponds to the repeating method of an access link of a repeater at the repeater side in embodiment 1, with identical contents being not going to be repeated herein any further. For example, this method is applicable to the network device 101 in FIG. 1 and FIG. 2.

FIG. 7 is a schematic diagram of the method for indicating a beam index of an access link of a repeater in embodiment 2 of this disclosure. As shown in FIG. 7, the method includes:
step 701: indicating a beam index of an access link by a network device to a repeater.

In some embodiments, the network device indicates the beam index of the access link via at least one of RRC signaling, an MAC CE and physical layer signaling.

In some embodiments, the network device indicates at least one of beam indices of the access link configured by the network device to the repeater; or, the network device indicates at least one of beam indices of the access link reported by the repeater to the repeater.

In some embodiments, the method further includes: receiving, by the network device, information reported by the repeater; and configuring the beam index of the access link by the network device according to the information reported by the repeater.

In some embodiments, the information reported by the repeater includes at least one of information on a number of beams supported by the access link, a relationship between beams of the access link, and whether simultaneous repeating on different beams of the access link is supported.

In some embodiments, the information on the number of beams supported by the access link includes at least one of the following: a total number of beams supported by the access link, a total number of repeated beams supported by the access link, a total number of simultaneously repeated beams supported by the access link, and the number of beams of different types.

In some embodiments, the method further includes: configuring the beam index of the access link by the network device.

In some embodiments,
for the case where the network device indicates at least one of the beam indices of the access link configured by the network device to the repeater, the method further includes: indicating information on a relationship between the beams to which the beam indices of the access link correspond by the network device to the repeater;
and for the case where the network device indicates at least one of the beam indices of the access link reported by the repeater to the repeater, the method further includes: receiving, by the network device, the beam index of the access link reported by the repeater; and receiving, by the network device, information on a relationship between beams to which the beam index of the access link reported by the repeater corresponds.

In some embodiments, the network device indicates at least one of beam indices of the access link reported by the repeater to the repeater, or, the network device indicates at least one of beam indices of the access link configured by the network device to the repeater.

In some embodiments, via RRC signaling, the network device configures at least one beam index in the beam indices of the access link configured by the network device or at least one beam index in the beam indices of the access link reported by the repeater; the network device activates a first part of the beam indices via an MAC CE; and the network device indicates a second part of the beam indices via a domain of physical layer signaling, the first part of the beam indices including at least one beam index in the beam indices configured by the RRC signaling, and the second part of the beam indices including at least one beam index in the first part of the beam indices. The beam index indicated by the network device to the repeater is the second part of beam indices.

In some embodiments, the relationship between the beams is a relationship between beams to which different beam indices correspond.

In some embodiments, the relationship between the beams includes that two beams are in different directions, or that two beams are in the same direction with different widths.

In some embodiments, the beam index received by the repeater is indicated a corresponding beam index by a first number of bits, or, the beam index indicated by the network device to the repeater is indicated a corresponding beam index in a manner of a bitmap.

In some embodiments, for the case where the beam index received by the repeater is indicated a corresponding beam index by a first number of bits, the first number is determined by a total number of beam indices of the access link, or, the first number is determined by a total number of repeated beams supported by the access link, or, the first number is determined by a total number of beam indices received by the repeater.

In some embodiments, for the case where the beam index received by the repeater is indicated a corresponding beam index in a manner of a bitmap, the number of bits of the bitmap is the total number of beam indices of the access link, or, the number of bits of the bitmap is the total number of repeated beams supported by the access link, or, the number of bits of the bitmap is the total number of beam indices received by the repeater.

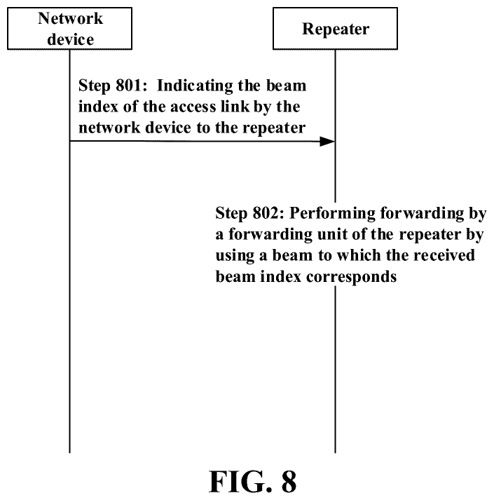

FIG. 8 is an interaction graph of carrying out the repeating method of an access link of a repeater of embodiment 2 of this disclosure. As shown in FIG. 8, the method includes:
step 801: indicating the beam index of the access link by the network device to the repeater; and
step 802: performing forwarding by a forwarding unit of the repeater by using a beam to which the received beam index corresponds.

The specific implementation methods of the above steps in FIGS. 7 and 8 may refer to the description in Embodiment 1, and will not be repeated here.

Reference may be made to the disclosure contained in embodiment 1 for implementations of the steps in FIG. 7 and FIG. 8, which shall not be repeated herein any further.

It can be seen from the above embodiment that the repeater performs forwarding on the access link by using the beam corresponding to the beam index of the access link according to the beam index of the access link received from the network device, so that the network device is able to schedule the access link beams of the repeater used for forwarding, and the repeater is able to determine the forwarded access link beams. Hence, the beam index may be effectively utilized and forwarding between the terminal and the network device may be completed.

### Embodiment 3

Embodiment 3 of this disclosure provides a repeating device of an access link of a repeater, the device being provided in a repeater. As a principle of the device for solving problems is similar to that of the method in embodiment 1, reference may be made to the implementation of the method described in embodiment 1 for implementation of the device, with identical or related contents being not going to be described herein any further.

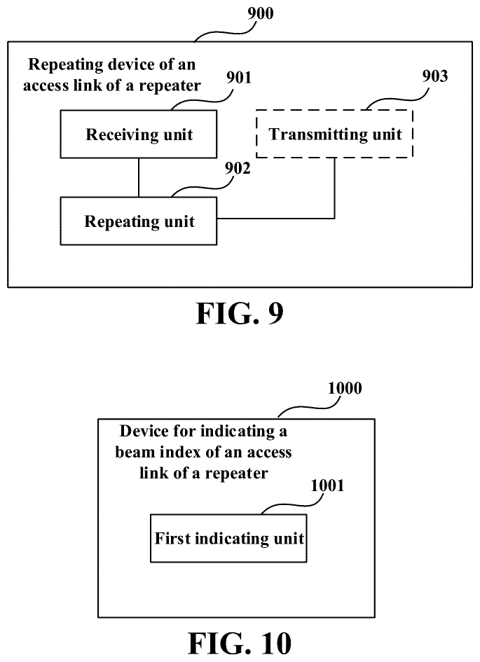

FIG. 9 is a schematic diagram of the repeating device of an access link of a repeater of embodiment 3 of this disclosure. As shown in FIG. 9, a repeating device 900 of an access link of a repeater includes:
a receiving unit 901 configured to receive a beam index of an access link from a network device; and
a repeating unit 902 configured to perform repeating by using a beam to which the received beam index corresponds.

In some embodiments, the receiving unit 901 is an NCR-MT or a part of an NCR-MT, and the repeating unit 902 is an NCR-Fwd.

In some embodiments, the beam index received by the repeater is indicated by at least one of RRC signaling, an MAC CE and physical layer signaling.

In some embodiments, the beam index received by the repeater is at least one of beam indices of an access link configured by the network device; or, the beam index received by the repeater is at least one of beam indices of an access link reported by the repeater.

In some embodiments, for a case where the beam index is configured by the network device, the beam index is configured by the network device according to information reported by the repeater.

In some embodiments, the information reported by the repeater includes: at least one of information on a number of beams supported by the access link, a relationship between beams of the access link, and whether simultaneous repeating on different beams of the access link is supported.

In some embodiments, the information on the number of beams supported by the access link includes at least one of the following: a total number of beams supported by the access link, a total number of repeated beams supported by the access link, a total number of simultaneously repeated beams supported by the access link, and the number of beams of different types.

In some embodiments, for the case where the beam index is at least one of the beam indices of the access link configured by the network device, the receiving unit 901 further receives information on a relationship between beams to which the beam indices correspond from the network device.

In some embodiments, for the case where the beam index is at least one of the beam indices of the access link reported by the repeater, as shown in FIG. 9, the device further includes:
a transmitting unit 903 configured to report information on a relationship between the beams to which the beam indices correspond to the network device.

In some embodiments, the transmitting unit 903 is an NCR-MT or a part of an NCR-MT.

In some embodiments, the network device configures at least one beam index in the beam indices of the access link configured by the network device or at least one beam index in the beam indices of the access link reported by the repeater via RRC signaling, activates a first part of beam indices via an MAC CE, and indicates a second part of the beam indices via a domain of physical layer signaling, the first part of beam indices including at least one beam index of beam indices configured by the RRC signaling, the second part of beam indices including at least one beam index of the first part of beam indices, and the beam indices received by the repeater being the second part of beam indices.

In some embodiments, the beam index received by the repeater includes a first beam index configured by the network device or reported by the repeater indicated by the network device, and a second beam index configured via RRC signaling and activated via an MAC CE by the network device and indicated by a domain of physical layer signaling.

In some embodiments, a beam of the repeater for repeating a broadcast signal corresponds to the first beam index indicated by the network device in mode 1 in embodiment 1, and a beam of the repeater for repeating a terminal-specific signal corresponds to the second beam index indicated by the network device in mode 2 in embodiment 1, and/or, a beam of the repeater for receiving semi-static beam configuration corresponds to the first beam index indicated by the network device in mode 1 in embodiment 1, and a beam of the repeater for receiving dynamic beam configuration corresponds to the second beam index indicated by the network device in mode 2 in embodiment 1, and/or, a wide beam of the access link of the repeater corresponds to the first beam index indicated by the network device in mode 1 in embodiment 1, and a narrow beam of the access link of the repeater corresponds to the second beam index indicated by the network device in mode 2 in embodiment 1.

In some embodiments, the relationship between the beams is a relationship between the beams to which the different beam indices correspond.

In some embodiments, the relationship between the beams at least includes that the beams to which the different beam indices correspond are in different directions, or that the beams to which the different beam indices correspond are in the same direction with different widths.

In some embodiments, the beam index received by the repeater is indicated a corresponding beam index by a first number of bits, or, the beam index received by the repeater is indicated a corresponding beam index in a manner of a bitmap.

In some embodiments, for the case where the beam index received by the repeater is indicated a corresponding beam index by a first number of bits, the first number is determined by a total number of beam indices of the access link, or, the first number is determined by a total number of repeated beams supported by the access link, or, the first number is determined by a total number of beam indices received by the repeater.

In some embodiments, for the case where the beam index received by the repeater is indicated a corresponding beam index in a manner of a bitmap, the number of bits of the bitmap is the total number of beam indices of the access link, or, the number of bits of the bitmap is the total number of repeated beams supported by the access link, or, the number of bits of the bitmap is the total number of beam indices received by the repeater.

Reference may be made to the disclosure contained in embodiment 1 for functions and contents of the above units, which shall not be repeated herein any further.

It can be seen from the above embodiment that the repeater performs forwarding on the access link by using the beam corresponding to the beam index of the access link according to the beam index of the access link received from the network device, so that the network device is able to schedule the access link beams of the repeater used for forwarding, and the repeater is able to determine the forwarded access link beams. Hence, the beam index may be effectively utilized and forwarding between the terminal and the network device may be completed.

### Embodiment 4

Embodiment 4 of this disclosure provides a device for indicating a beam index of an access link of a repeater, applicable to a network device side. As a principle of the device for solving problems is similar to that of the method in embodiment 2, reference may be made to the implementation of the method described in embodiment 2 for implementation of the device, with identical or related contents being not going to be described herein any further.

FIG. 10 is a schematic diagram of the device for indicating a beam index of an access link of a repeater of embodiment 4 of this disclosure. As shown in FIG. 10, a device 1000 for indicating a beam index of an access link of a repeater includes:
a first indicating unit 1001 configured to indicate a beam index of an access link to a repeater.

In some embodiments, the network device indicates the beam index of the access link via at least one of RRC signaling, an MAC CE and physical layer signaling.

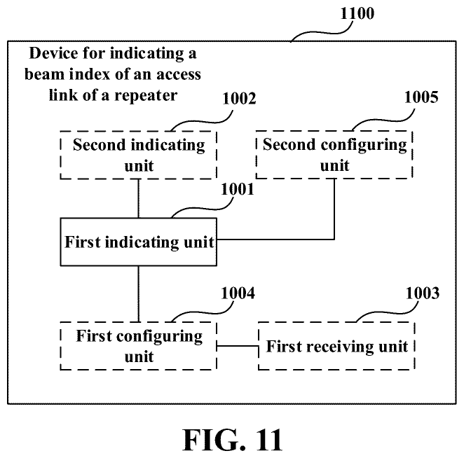

FIG. 11 is another schematic diagram of the device for indicating a beam index of an access link of a repeater of embodiment 4 of this disclosure. As shown in FIG. 11, a device 1100 for indicating a beam index of an access link of a repeater includes:
a first indicating unit 1001 configured to indicate a beam index of an access link to a repeater.

In some embodiments, for the case where the network device configures the beam index of the access link, the device further includes:
a second indicating unit 1002 configured to indicate information on a relationship between beams to which the beam index of the access link corresponds.

In some embodiments, for the case where the network device configures the beam index of the access link, the device further includes:
a first receiving unit 1003 configured to receive information reported by the repeater; and
a first configuring unit 1004 configured to configure the beam index of the access link according to the information reported by the repeater.

In some embodiments, the information reported by the repeater includes at least one of information on a number of beams supported by the access link, a relationship between beams of the access link, and whether simultaneous repeating on different beams of the access link is supported.

In some embodiments, the information on the number of beams supported by the access link includes at least one of the following: a total number of beams supported by the access link, a total number of repeated beams supported by the access link, a total number of simultaneously repeated beams supported by the access link, and the number of beams of different types.

Or, in some embodiments, for the case where the network device configures the beam index of the access link, the device further includes:
a second configuring unit 1005 configured to configure the beam index of the access link. That is, the network device independently determines the beam index of the access link.

For example, the first receiving unit 1003 and the first configuring unit 1004 may be replaced with the second configuring unit 1005.

The second indicating unit 1002, the first receiving unit 1003, the first configuring unit 1004 and the second configuring unit 1005 are optional.

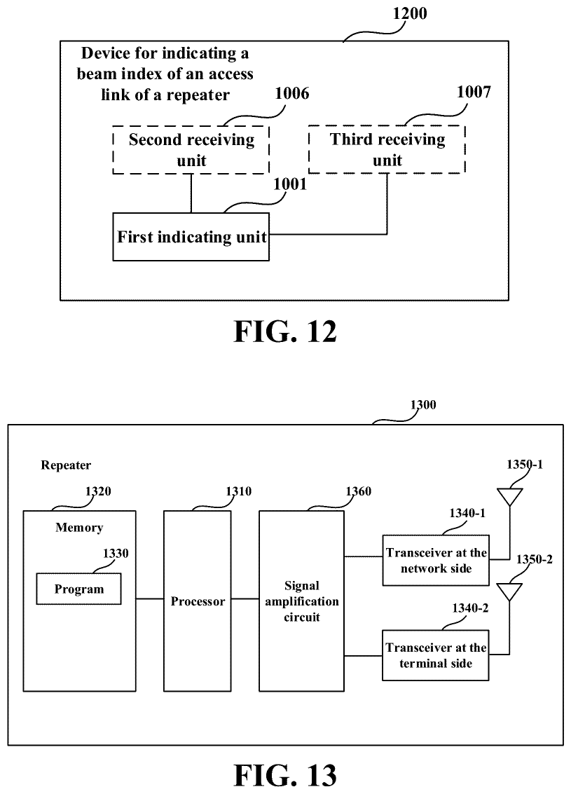

FIG. 12 is a further schematic diagram of the device for indicating a beam index of an access link of a repeater of embodiment 4 of this disclosure. As shown in FIG. 12, a device 1200 for indicating a beam index of an access link of a repeater includes:
a first indicating unit 1001 configured to indicate a beam index of an access link to the repeater.

In some embodiments, for the case where the repeater reports the beam index of the access link, the device further includes:
a second receiving unit 1006 configured to receive the beam index of the access link reported by the repeater; and
a third receiving unit 1007 configured to receive information on a relationship between beams to which the beam index of the access link corresponds reported by the repeater.

The second receiving unit 1006 and the third receiving unit 1007 are optional.

In some embodiments, via RRC signaling, the network device configures at least one beam index in the beam indices of the access link configured by the network device or at least one beam index in the beam indices of the access link reported by the repeater; the network device activates a first part of the beam indices via an MAC CE; and the network device indicates a second part of the beam indices via a domain of physical layer signaling, the first part of the beam indices including at least one beam index in the beam indices configured by the RRC signaling, and the second part of the beam indices including at least one beam index in the first part of the beam indices. The beam index indicated by the network device to the repeater is the second part of beam indices.

In some embodiments, the relationship between the beams is a relationship between beams to which different beam indices correspond.

In some embodiments, the relationship between the beams includes that two beams are in different directions, or that two beams are in the same direction with different widths.

In some embodiments, the beam index indicated by the network device to the repeater is indicated a corresponding beam index by a first number of bits, or, the beam index indicated by the network device to the repeater is indicated a corresponding beam index in a manner of a bitmap.

In some embodiments, for the case where the beam index indicated by the network device to the repeater is indicated a corresponding beam index by a first number of bits, the first number is determined by a total number of beam indices of the access link, or, the first number is determined by a total number of repeated beams supported by the access link, or, the first number is determined by a total number of beam indices received by the repeater.

In some embodiments, for the case where the beam index received by the repeater is indicated a corresponding beam index in a manner of a bitmap, the number of bits of the bitmap is the total number of beam indices of the access link, or, the number of bits of the bitmap is the total number of repeated beams supported by the access link, or, the number of bits of the bitmap is the total number of beam indices received by the repeater.

Reference may be made to the disclosure contained in embodiment 2 for functions and contents of the above units, which shall not be repeated herein any further.

It can be seen from the above embodiment that the repeater performs forwarding on the access link by using the beam corresponding to the beam index of the access link according to the beam index of the access link received from the network device, so that the network device is able to schedule the access link beams of the repeater used for forwarding, and the repeater is able to determine the forwarded access link beams. Hence, the beam index may be effectively utilized and forwarding between the terminal and the network device may be completed.

### Embodiment 5

Embodiment 5 of this disclosure provides a repeater, including the repeating device of an access link of a repeater described in embodiment 3.

FIG. 13 is a block diagram of a systematic structure of a repeater of embodiment 5 of this disclosure. As shown in FIG. 13, a repeater 1300 may include a processor 1310 and a memory 1320, the memory 1320 being coupled to the processor 1310, wherein, the memory 1320 may store various data, and furthermore, it may store a program 1330 for information processing, and executes the program 1330 under control of the processor 1310. It should be noted that this figure is illustrative only, and other types of structures may also be used, so as to supplement or replace this structure and achieve a telecommunications function or other functions.

In one implementation, the functions of the repeating device of an access link of a repeater may be integrated into the processor 1310. Wherein, the processor 1310 may be configured to: receive a beam index of an access link by a receiving unit of the repeater from a network device; and perform repeating by a repeating unit of the repeater by using a beam to which the received beam index corresponds.

In another implementation, the repeating device of an access link of a repeater and the processor 1310 may be configured separately; for example, the repeating device of an access link of a repeater may be configured as a chip connected to the processor 1310, and the functions of the repeating device of an access link of a repeater are executed under control of the processor 1310.

As shown in FIG. 13, the repeater 1300 may further include a transceiver 1340-1 at the network side and an antenna 1350-1 at the network side, a transceiver 1340-2 at the terminal side and an antenna 1350-2 at the terminal side, and a signal amplification circuit 1360, etc. Wherein, functions of the above components are similar to those in the related art, and shall not be described herein any further. It should be noted that the repeater 1300 does not necessarily include all the parts shown in FIG. 13. Furthermore, the repeater 1300 may include parts not shown in FIG. 13, and the related art may be referred to.

As shown in FIG. 13, the processor 1310 is sometimes referred to as a controller or an operational control, which may include a microprocessor or other processor devices and/or logic devices. The processor 1310 receives input and controls operations of components of the repeater 1300.

Wherein, the memory 1320 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 1310 may execute programs stored in the memory 1320, so as to realize information storage or processing, etc. Functions of other parts are similar to those of the related art, which shall not be described herein any further.

The parts of the repeater 1300 may be realized by specific hardware, firmware, software, or any combination thereof, without departing from the scope of this disclosure.

It can be seen from the above embodiment that the repeater performs forwarding on the access link by using the beam corresponding to the beam index of the access link according to the beam index of the access link received from the network device, so that the network device is able to schedule the access link beams of the repeater used for forwarding, and the repeater is able to determine the forwarded access link beams. Hence, the beam index may be effectively utilized and forwarding between the terminal and the network device may be completed.

### Embodiment 6

The embodiment of this disclosure provides a network device, including the device for indicating a beam index of an access link of a repeater as described in embodiment 4.

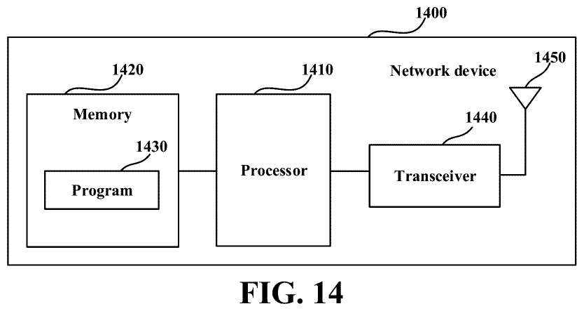

FIG. 14 is a schematic diagram of a systematic structure of the network device of embodiment 6 of this disclosure. As shown in FIG. 14, a network device 1400 may include a processor 1410 and a memory 1420, the memory 1420 being coupled to the processor 1410.

Wherein, the memory 1420 may store various data, and furthermore, it may store a program 1430 for data processing, and execute the program 1430 under control of the processor 1410, so as to receive various information transmitted by a repeater, and transmit various information to the repeater.

In one implementation, the functions of the device for indicating a beam index of an access link of a repeater may be integrated into the processor 1410. Wherein, the processor 1410 may be configured to: indicate a beam index of an access link by a network device to the repeater.

Furthermore, as shown in FIG. 14, the network device 1400 may include a transceiver 1440, and an antenna 1450, etc. Wherein, functions of the above components are similar to those in the related art, and shall not be described herein any further. It should be noted that the network device 1400 does not necessarily include all the parts shown in FIG. 14. Furthermore, the network device 1400 may include parts not shown in FIG. 14, and the related art may be referred to.

It can be seen from the above embodiment that the repeater performs forwarding on the access link by using the beam corresponding to the beam index of the access link according to the beam index of the access link received from the network device, so that the network device is able to schedule the access link beams of the repeater used for forwarding, and the repeater is able to determine the forwarded access link beams. Hence, the beam index may be effectively utilized and forwarding between the terminal and the network device may be completed.

### Embodiment 7

The embodiment of this disclosure provides a communication system, including the repeater described in embodiment 5 and/or the network device described in embodiment 6.

For example, reference may be made to FIGS. 1 and 2 for a structure of the communication system.

As shown in FIG. 1, the communication system 100 includes the network device 101, the terminal equipment 102 and the repeater 103. The repeater 103 may be identical to the repeater described in embodiment 5, and the network device 101 may be identical to the network device described in embodiment 6, with repeated parts being not going to be described herein any further.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 9 may either correspond to software modules of procedures of a computer program, or correspond to hardware modules. Such software modules may respectively correspond to the steps shown in FIG. 3. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 9 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 9 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

As to the implementations including the above embodiments, following supplements are further disclosed.

### Supplement I

1. A repeating device of an access link of a repeater, the device being provided in a repeater, and the device including:
a receiving unit configured to receive a beam index of an access link from a network device; and
a repeating unit configured to perform repeating by using a beam to which the received beam index corresponds.
2. The device according to supplement 1, wherein,
the beam index received by the repeater is indicated by at least one of RRC signaling, an MAC CE and physical layer signaling.
3. The device according to supplement 1, wherein,
the beam index received by the repeater is at least one of beam indices of an access link configured by the network device; or,
the beam index received by the repeater is at least one of beam indices of an access link reported by the repeater.
4. The device according to supplement 3, wherein,
for a case where the beam index is configured by the network device, the beam index is configured by the network device according to information reported by the repeater.
5. The device according to supplement 4, wherein the information reported by the repeater includes:
at least one of information on a number of beams supported by the access link, a relationship between beams of the access link, and whether simultaneous repeating on different beams of the access link is supported.
6. The device according to supplement 5, wherein the information on the number of beams supported by the access link includes at least one of the following:
a total number of beams supported by the access link, a total number of repeated beams supported by the access link, a total number of simultaneously repeated beams supported by the access link, and the number of beams of different types.
7. The device according to supplement 3, wherein for the case where the beam index is at least one of the beam indices of the access link configured by the network device,
the receiving unit further receives information on a relationship between beams to which the beam indices correspond from the network device.
8. The device according to supplement 3, wherein for the case where the beam index is at least one of the beam indices of the access link reported by the repeater, the device further includes:
a transmitting unit configured to report information on a relationship between the beams to which the beam indices correspond to the network device.
9. The device according to any one of supplements 2-8, wherein,
the network device configures at least one beam index in the beam indices of the access link configured by the network device or at least one beam index in the beam indices of the access link reported by the repeater via RRC signaling, activates a first part of beam indices via an MAC CE, and indicates a second part of the beam indices via a domain of physical layer signaling,
the first part of beam indices including at least one beam index of beam indices configured by the RRC signaling,
the second part of beam indices including at least one beam index of the first part of beam indices,
and the beam indices received by the repeater being the second part of beam indices.
10. The device according to any one of supplements 2-9, wherein,
the beam index received by the repeater includes a first beam index configured by the network device or reported by the repeater indicated by the network device, and a second beam index configured via RRC signaling and activated via an MAC CE by the network device and indicated by a domain of physical layer signaling.
11. The device according to supplement 10, wherein,
a beam of the repeater for repeating a broadcast signal corresponds to the first beam index indicated by the network device, and a beam of the repeater for repeating a terminal-specific signal corresponds to the second beam index indicated by the network device, and/or,
a beam of the repeater for receiving semi-static beam configuration corresponds to the first beam index indicated by the network device, and a beam of the repeater for receiving dynamic beam configuration corresponds to the second beam index indicated by the network device, and/or,
a wide beam of the access link of the repeater corresponds to the first beam index indicated by the network device, and a narrow beam of the access link of the repeater corresponds to the second beam index indicated by the network device.
12. The device according to any one of supplements 5, 7 and 8, wherein,
the relationship between the beams is a relationship between the beams to which the different beam indices correspond.
13. The device according to supplement 12, wherein,
the relationship between the beams at least includes that the beams to which the different beam indices correspond are in different directions, or that the beams to which the different beam indices correspond are in the same direction with different widths.
14. The device according to supplement 1 or 2, wherein,
the beam index received by the repeater is indicated a corresponding beam index by a first number of bits, or,
the beam index received by the repeater is indicated a corresponding beam index in a manner of a bitmap.
15. The device according to supplement 14, wherein for the case where the beam index received by the repeater is indicated a corresponding beam index by a first number of bits,
the first number is determined by a total number of beam indices of the access link, or,
the first number is determined by a total number of repeated beams supported by the access link, or,
the first number is determined by a total number of beam indices received by the repeater.
16. The device according to supplement 14, wherein for the case where the beam index received by the repeater is indicated a corresponding beam index in a manner of a bitmap,
the number of bits of the bitmap is the total number of beam indices of the access link, or,
the number of bits of the bitmap is the total number of repeated beams supported by the access link, or,
the number of bits of the bitmap is the total number of beam indices received by the repeater.
17. A device for indicating a beam index of an access link of a repeater, the device being provided in a network device, and the device including:
a first indicating unit configured to indicate a beam index of an access link to a repeater.
18. The device according to supplement 17, wherein,
the network device indicates the beam index of the access link via at least one of RRC signaling, an MAC CE and physical layer signaling.
19. The device according to supplement 17, wherein,
the network device indicates at least one of beam indices of the access link configured by the network device to the repeater; or,
the network device indicates at least one of beam indices of the access link reported by the repeater to the repeater.
20. The device according to supplement 17, wherein the device further includes:
a first receiving unit configured to receive information reported by the repeater; and
a first configuring unit configured to configure the beam index of the access link according to the information reported by the repeater.
21. The device according to supplement 20, wherein the information reported by the repeater includes:
at least one of information on a number of beams supported by the access link, a relationship between beams of the access link, and whether simultaneous repeating on different beams of the access link is supported.
22. The device according to supplement 21, wherein the information on the number of beams supported by the access link includes at least one of the following:
a total number of beams supported by the access link, a total number of repeated beams supported by the access link, a total number of simultaneously repeated beams supported by the access link, and the number of beams of different types.
23. The device according to supplement 17, wherein the device further includes:
a second configuring unit configured to configure the beam index of the access link.
24. The device according to supplement 17, wherein the device further includes:
a second indicating unit configured to indicate information on a relationship between beams to which the beam index of the access link corresponds;
or, the device further includes:
a second receiving unit configured to receive the beam index of the access link reported by the repeater; and
a third receiving unit configured to receive information on a relationship between beams to which the beam index of the access link corresponds reported by the repeater.
25. The device according to any one of supplements 19-24, wherein,
the network device configures at least one beam index in the beam indices of the access link configured by the network device or at least one beam index in the beam indices of the access link reported by the repeater via RRC signaling,
the network device activates a first part of beam indices via an MAC CE,
and the network device indicates a second part of the beam indices via a domain of physical layer signaling,
the first part of beam indices including at least one beam index of beam indices configured by the RRC signaling,
the second part of beam indices including at least one beam index of the first part of beam indices,
and the beam indices received by the repeater being the second part of beam indices.
26. The device according to supplement 21 or 24, wherein,
the relationship between the beams is a relationship between the beams to which the different beam indices correspond.
27. The device according to supplement 26, wherein,
the relationship between the beams includes: that two beams are in different directions, or that two beams are in the same direction with different widths.
28. The device according to supplement 1 or 2, wherein,
the beam index indicated by the network device to the repeater is indicated a corresponding beam index by a first number of bits, or,
the beam index indicated by the network device to the repeater is indicated a corresponding beam index in a manner of a bitmap.
29. The device according to supplement 28, wherein for the case where the beam index is indicated a corresponding beam index by a first number of bits,
the first number is determined by a total number of beam indices of the access link, or,
the first number is determined by a total number of repeated beams supported by the access link, or,
the first number is determined by a total number of beam indices received by the repeater.
30. The device according to supplement 28, wherein for the case where the beam index is indicated a corresponding beam index in a manner of a bitmap,
the number of bits of the bitmap is the total number of beam indices of the access link, or,
the number of bits of the bitmap is the total number of repeated beams supported by the access link, or,
the number of bits of the bitmap is the total number of beam indices received by the repeater.
31. A repeater, including the device as described in any one of supplements 1-16.
32. A network device, including the device as described in any one of supplements 17-30.
33. A communications system, including the repeater as described in supplement 31 and/or the network device as described in supplement 32.

### Supplement II

1. A repeating method of an access link of a repeater, the method including:
receiving a beam index of an access link by a receiving unit of the repeater from a network device; and
performing repeating by a repeating unit of the repeater by using a beam to which the received beam index corresponds.
2. The method according to supplement 1, wherein,
the beam index received by the repeater is indicated by at least one of RRC signaling, an MAC CE and physical layer signaling.
3. The method according to supplement 1, wherein,
the beam index received by the repeater is at least one of beam indices of an access link configured by the network device; or,
the beam index received by the repeater is at least one of beam indices of an access link reported by the repeater.
4. The method according to supplement 3, wherein,
for a case where the beam index is configured by the network device, the beam index is configured by the network device according to information reported by the repeater.
5. The method according to supplement 4, wherein the information reported by the repeater includes:
at least one of information on a number of beams supported by the access link, a relationship between beams of the access link, and whether simultaneous repeating on different beams of the access link is supported.
6. The method according to supplement 5, wherein the information on the number of beams supported by the access link includes at least one of the following:
a total number of beams supported by the access link, a total number of repeated beams supported by the access link, a total number of simultaneously repeated beams supported by the access link, and the number of beams of different types.
7. The method according to supplement 3, wherein for the case where the beam index is at least one of the beam indices of the access link configured by the network device, the method further includes:
receiving information on a relationship between beams to which the beam indices correspond by the repeater from the network device.
8. The method according to supplement 3, wherein for the case where the beam index is at least one of the beam indices of the access link reported by the repeater, the method further includes:
reporting information on a relationship between the beams to which the beam indices correspond by the repeater to the network device.
9. The method according to any one of supplements 2-8, wherein,
the network device configures at least one beam index in the beam indices of the access link configured by the network device or at least one beam index in the beam indices of the access link reported by the repeater via RRC signaling, activates a first part of beam indices via an MAC CE, and indicates a second part of the beam indices via a domain of physical layer signaling,
the first part of beam indices including at least one beam index of beam indices configured by the RRC signaling,
the second part of beam indices including at least one beam index of the first part of beam indices,
and the beam indices received by the repeater being the second part of beam indices.
10. The method according to any one of supplements 2-9, wherein,
the beam index received by the repeater includes a first beam index configured by the network device or reported by the repeater indicated by the network device, and a second beam index configured via RRC signaling and activated via an MAC CE by the network device and indicated by a domain of physical layer signaling.
11. The method according to supplement 10, wherein,
a beam of the repeater for repeating a broadcast signal corresponds to the first beam index indicated by the network device, and a beam of the repeater for repeating a terminal-specific signal corresponds to the second beam index indicated by the network device, and/or,
a beam of the repeater for receiving semi-static beam configuration corresponds to the first beam index indicated by the network device, and a beam of the repeater for receiving dynamic beam configuration corresponds to the second beam index indicated by the network device, and/or,
a wide beam of the access link of the repeater corresponds to the first beam index indicated by the network device, and a narrow beam of the access link of the repeater corresponds to the second beam index indicated by the network device.
12. The method according to any one of supplements 5, 7 and 8, wherein,
the relationship between the beams is a relationship between the beams to which the different beam indices correspond.
13. The method according to supplement 12, wherein,
the relationship between the beams at least includes that the beams to which the different beam indices correspond are in different directions, or that the beams to which the different beam indices correspond are in the same direction with different widths.
14. The method according to supplement 1 or 2, wherein,
the beam index received by the repeater is indicated a corresponding beam index by a first number of bits, or,
the beam index received by the repeater is indicated a corresponding beam index in a manner of a bitmap.
15. The method according to supplement 14, wherein for the case where the beam index received by the repeater is indicated a corresponding beam index by a first number of bits,
the first number is determined by a total number of beam indices of the access link, or,
the first number is determined by a total number of repeated beams supported by the access link, or,
the first number is determined by a total number of beam indices received by the repeater.
16. The method according to supplement 14, wherein for the case where the beam index received by the repeater is indicated a corresponding beam index in a manner of a bitmap,
the number of bits of the bitmap is the total number of beam indices of the access link, or,
the number of bits of the bitmap is the total number of repeated beams supported by the access link, or,
the number of bits of the bitmap is the total number of beam indices received by the repeater.
17. A method for indicating a beam index of an access link of a repeater, the method including:
indicating a beam index of an access link by a network device to a repeater.
18. The method according to supplement 17, wherein,
the network device indicates the beam index of the access link via at least one of RRC signaling, an MAC CE and physical layer signaling.
19. The method according to supplement 17, wherein,
the network device indicates at least one of beam indices of the access link configured by the network device to the repeater; or,
the network device indicates at least one of beam indices of the access link reported by the repeater to the repeater.
20. The method according to supplement 17, wherein the method further includes:
receiving, by the network device information reported by the repeater; and
configuring the beam index of the access link by the network device according to the information reported by the repeater.
21. The method according to supplement 20, wherein the information reported by the repeater includes:
at least one of information on a number of beams supported by the access link, a relationship between beams of the access link, and whether simultaneous repeating on different beams of the access link is supported.
22. The method according to supplement 21, wherein the information on the number of beams supported by the access link includes at least one of the following:
a total number of beams supported by the access link, a total number of repeated beams supported by the access link, a total number of simultaneously repeated beams supported by the access link, and the number of beams of different types.
23. The method according to supplement 17, wherein the method further includes:
configuring the beam index of the access link by the network device.
24. The method according to supplement 17, wherein the method further includes:
indicating information on a relationship between beams to which the beam index of the access link corresponds by the network device;
or, the method further includes:
receiving, by the network device, the beam index of the access link reported by the repeater; and
receiving, by the network device, information on a relationship between beams to which the beam index of the access link corresponds reported by the repeater.
25. The method according to any one of supplements 19-24, wherein,
the network device configures at least one beam index in the beam indices of the access link configured by the network device or at least one beam index in the beam indices of the access link reported by the repeater via RRC signaling,
the network device activates a first part of beam indices via an MAC CE,
and the network device indicates a second part of the beam indices via a domain of physical layer signaling,
the first part of beam indices including at least one beam index of beam indices configured by the RRC signaling,
the second part of beam indices including at least one beam index of the first part of beam indices,
and the beam indices received by the repeater being the second part of beam indices.
26. The method according to supplement 21 or 24, wherein,
the relationship between the beams is a relationship between the beams to which the different beam indices correspond.
27. The method according to supplement 26, wherein,
the relationship between the beams includes: that two beams are in different directions, or that two beams are in the same direction with different widths.
28. The method according to supplement 1 or 2, wherein,
the beam index indicated by the network device to the repeater is indicated a corresponding beam index by a first number of bits, or,
the beam index indicated by the network device to the repeater is indicated a corresponding beam index in a manner of a bitmap.
29. The method according to supplement 28, wherein for the case where the beam index is indicated a corresponding beam index by a first number of bits,
the first number is determined by a total number of beam indices of the access link, or,
the first number is determined by a total number of repeated beams supported by the access link, or,
the first number is determined by a total number of beam indices received by the repeater.
30. The method according to supplement 28, wherein for the case where the beam index is indicated a corresponding beam index in a manner of a bitmap,
the number of bits of the bitmap is the total number of beam indices of the access link, or,
the number of bits of the bitmap is the total number of repeated beams supported by the access link, or,
the number of bits of the bitmap is the total number of beam indices received by the repeater.

1. A network controlled repeater (NCR), comprising:
a NCR-MT (Mobile Termination) processor circuitry configured to receive a beam index of an access link from a network device; and
a NCR-Fwd (Forwarding) processor circuitry configured to perform forwarding on the access link by using a beam to which a received beam index corresponds.

2. The network controlled repeater according to claim 1, wherein,
the beam index received by the repeater is indicated by at least one of RRC (Radio Resource Control) signaling, an MAC CE (Control Element) and physical layer signaling.

3. The network controlled repeater according to claim 1, wherein,
the beam index received by the repeater is at least one of beam indexes of an access link configured by the network device.

4. The network controlled repeater according to claim 2, wherein,
the beam index received by the repeater comprises a first beam index configured by the network device or reported by the repeater indicated by the network device, and a second beam index configured via RRC signaling and activated via an MAC CE and indicated by a domain of physical layer signaling by the network device.

5. The network controlled repeater according to claim 4, wherein,
a beam of the repeater for receiving semi-static beam configuration corresponds to the first beam index indicated by the network device, and a beam of the repeater for receiving dynamic beam configuration corresponds to the second beam index indicated by the network device.

6. The device according to claim 1, wherein,
the beam index received by the repeater is indicated a corresponding beam index by a first number of bits.

7. The device according to claim 6, wherein for the case where the beam index received by the repeater is indicated a corresponding beam index by a first number of bits,
the first number is determined by a total number of beam indexes of the access link.

8. A network device, comprising:
a transmitter configured to indicate a beam index of an access link to a network controlled repeater (NCR).

9. The network device according to claim 8, wherein,
the network device indicates the beam index of the access link via at least one of RRC signaling, an MAC CE (Control Element) and physical layer signaling.

10. The network device according to claim 8, wherein,
the network device indicates at least one of beam indexes of the access link configured by the network device to the repeater.

11. The network device according to claim 9, wherein,
the beam index indicated by the network device comprises a first beam index configured by the network device, and a second beam index configured via RRC signaling and activated via an MAC CE by the network device and indicated by a domain of physical layer signaling.

12. The network device according to claim 11, wherein,
a beam of semi-static beam configuration configured by the network device corresponds to the first beam index indicated by the network device, and a beam of dynamic beam configuration configured by the network device corresponds to the second beam index indicated by the network device.

13. A communications system, comprising a network controlled repeater (NCR) and/or a network device,
the network controlled repeater comprising:
a NCR-MT (Mobile Termination) processor circuitry configured to receive a beam index of an access link from a network device; and
a NCR-Fwd (Forwarding) processor circuitry configured to perform forwarding on the access link by using a beam to which a received beam index corresponds,
the network device comprising:
a transmitter configured to indicate a beam index of an access link to a network controlled repeater (NCR).
